(19) United States
(12) Patent Application Publication
(10) Pub. No.: US 2006/0182060 A1
(43) Pub. Date: Aug. 17, 2006

(54) Method for data transmission manage in ue switch process

(76) Inventors: Ping Lin, Guangdong (CN); Chun Zhang, Guangdong (CN); Daoli Zhang, Guangdong (CN)

Correspondence Address: LADAS & PARRY LLP, 224 SOUTH MICHIGAN AVENUE, SUITE 1600, CHICAGO, IL, 60604, US

(21) Appl. No.: 10/551,817

(22) PCT Filed: Apr. 9, 2003
(86) PCT No.: PCT/CN03/00253

§ 371 Date: Sep. 30, 2005

(51) Int. Cl. H04Q 7/00

(52) U.S. Cl. 370/331; 370/401

(57) ABSTRACT

The invention provides a method for managing data transmission performed in a radio network controller during UE handover procedure. The method is performed in a RNC having a distributed architecture, and comprises the following steps: acquiring a handover request transmitted by UE from a first ATM interface board, by one of the plurality of radio signaling management boards; creating mapping between one of the plurality of data transmission management boards and a second ATM interface board, by the radio signaling management board, said data transmission management board having mapping to the first ATM interface board before handover; and informing UE of performing data transmission between the data transmission management board and the second ATM interface board, by the radio signaling management board. When UE executes handover between two cells dominated by the same RNC, the method avoids frequent shifting of data of the same UE between different data transmission management boards, thereby decreasing the load in the procedure of transmitting and handling of system signaling, improving effective handling capability of the system, and additionally reducing the probability of losing data packets of the system.

### FIELD OF THE INVENTION

The present invention generally relates to a radio network controller, and more particularly, to a method for managing data transmission performed in a radio network controller during an user equipment (UE) handover procedure.

### BACKGROUND OF THE INVENTION

The radio network controller (RNC) is an important component in the third generation mobile communication wideband code division multiple access system (3G W-CDMA), which performs important functions such as access control of a radio network, management of radio resources, establishment and release of radio links, etc. The method for managing data transmission during the UE handover procedure is realized in a radio network controller having distributed architecture. In the distributed radio network controller, the function of managing radio signaling and the function of managing data transmission are respectively realized in different processing boards. Each of the functions may be realized in one processing board or collectively realized by a plurality of processing boards. Since the amount of data flow is comparatively large, the function of managing data transmission is generally realized in the plurality of processing boards, with one processing board providing services for a certain number of handsets (UEs).

The radio network controller is responsible for allocating radio resources for handsets (UEs) and managing data transmission of UEs, when participating in the mobility management of users. At present, larger capacity and fewer office addresses is a common desire for most operators, which subjectively requires that a single RNC has substantially large service process capability and dominates relatively more cells. Therefore, most handovers of UE may be executed between cells dominated by the same RNC. For a RNC having a distributed architecture, since there are a plurality of processing boards (data transmission management boards) collectively provide services to the cells dominated by the RNC, when UE executes handover between two cells dominated by the same RNC, how to avoid frequent shifting of data transmission of the same UE between different data transmission management boards is a problem faced by RNC equipment providers.

In the prior art, when an UE executes handover between different cells dominated by the same RNC, corresponding data transmission management boards are shifted before and after the handover. FIG. 1 show a process of handover from Cell1 to Cell2 of the same UE, by way of example.

The initial location of UE is Cell1, and the data transmission route at this time is:
UE← →ATM1← →DTM1← →CN/RSM

When UE is shifted to Cell2, the data transmission route is:
UE← →ATM2← →DTM2← →CN/RSM

It can be seen from FIG. 1 that, when UE executes handovers from Cell 1 to Cell2, in the data transmission route, not only the interface ATM board is changing from ATM1 to ATM2, but the data transmission management board (DTM) has also changed, i.e. from DTM1 to DTM2. The change of the data transmission management board requires that information about UE is also transferred from DTM1 to DTM2. The task of transferring the information about UE from DTM1 to DTM2 is performed by a radio signaling management board (RSM). The information about UE will be reallocated to DTM2 through the radio signaling management board. The UE information required to be shifted comprises: status information of UE, radio bearer information (comprising signaling bearer and service bearer information), transmission channel information, and parameter configuration information relative to IU interface (IU-UP or GTPU parameter information).

When UE executes handover between different cells, if data about UE needs to be shifted between different data transmission management boards, the following problems will arise: when UE frequently executes handover, if UE is located at the edge of two cells, a ping-pong handover will occurs, this will increase signaling load between boards, thereby degrading call handling capability of the RNC system and making the system unstable. For the services transmitted by a TM (transparent transmission mode) or UM (unacknowledged transmission mode), since there exists an interval of handover, data packets will lose. For the services transmitted by a AM mode, in the interval of handover, the probability of retransmitting data packets will increase, and the system load will be added unnecessarily.

### SUMMARY OF THE INVENTION

The invention provides a method for managing data transmission during UE handover procedure to solve the above problems, which avoids the various defects of increasing signaling load between data transmission management boards, increasing possibility of data packets loss and radio link break and unnecessarily increasing system load, due to frequent shifting of UE data between different data transmission management boards, during UE handover between different cells.

The technical solution to achieve the invention is to provide a method for managing data transmission during UE handover procedure used in a RNC having distributed architecture, said RNC comprising a radio signaling management module composed of one or more radio signaling management boards, a data transmission management module composed of one or more data transmission management boards, an interface management module and interface ATM boards, characterized in that the method comprises the following steps: acquiring a handover request transmitted by UE from a first ATM interface board, by one of the plurality of radio signaling management boards; creating mapping between one of the plurality of data transmission management boards and a second ATM interface board, by the radio signaling management board, said data transmission management board having mapping to the first ATM interface board before handover; and informing UE of performing data transmission between the data transmission management board and the second ATM interface board, by the radio signaling management board.

Compared with the prior art, with the method for managing data transmission of the invention, the management of data transmission of UE is fixed in one data transmission management board for handling during UE handover procedure, which avoids shifting of large amount of UE information data between different data transmission management boards, decreases the load in the procedure of transmitting and handling of system signaling, and improves effective handling capability of the system. In addition, since complex signaling handling is not required any more, the interval of handover is minimized, which reduces the probability of losing data packets of the system.

The invention will be described below in detail in conjunction with the accompanying drawings and specific embodiments.

### BRIEF DESCRIPTION OF THE DRAWINGS

FIG. 1 is a schematic diagram showing UE handover between different cells inside the same RNC in the prior art;

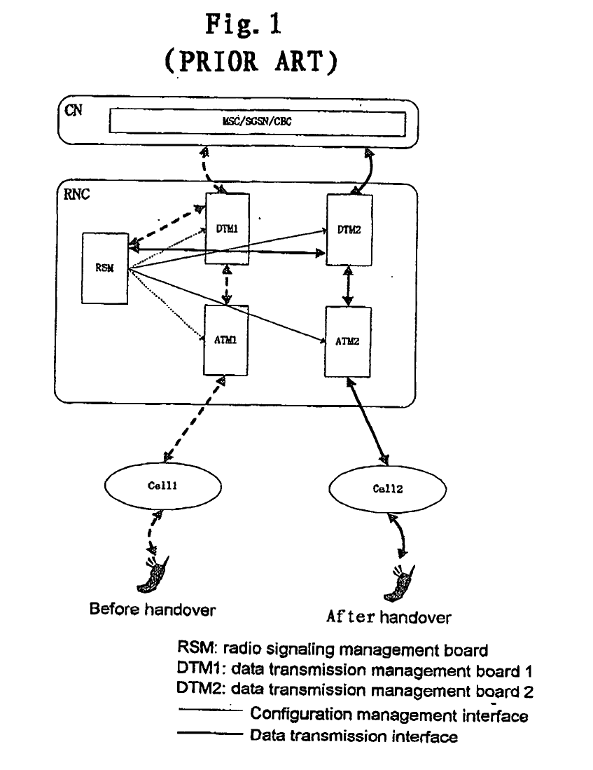

FIG. 2 is a schematic diagram showing the structure of a distributed radio network controller used in an embodiment of the invention;

FIG. 3 is a schematic diagram showing the use of the data transmission management boards when UE executes handover between different cells in the same RNC, according to the specific embodiment of the invention.

FIG. 4 is a flowchart diagram showing a process from call setup to handover complete of UE, according to the specific embodiment of the invention.

FIG. 5 is a flowchart diagram showing the method for managing data transmission during UE handover procedure, according to the specific embodiment of the invention.

### DETAILED DESCRIPTION OF THE PREFERRED EMBODIMENT

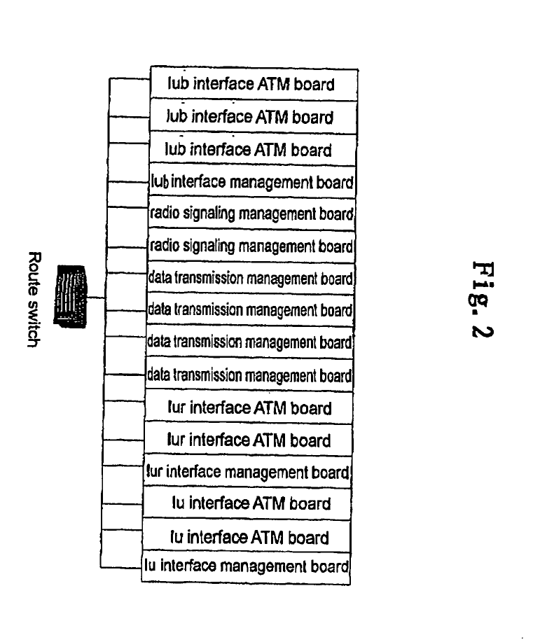

FIG. 2 is a schematic diagram showing the structure of a distributed radio network controller used in the embodiment of the invention. It should be noted that, the invention is not limited to the specific structure as shown in FIG. 2, and the radio network controller may use a plurality of switching methods such as ATM switch and IP switch supporting quality of service (QoS), when transmitting information with other network elements in the system. The radio network controller participates in the mobility management of the users, and is responsible for the allocation of radio resources for UE and the management of data transmission of UE, when UE executes a handover between different cells dominated by the same radio network controller.

The distributed radio network controller as shown in FIG. 2 has the following structure:

For physical interfaces, there are three interfaces between RNC and external network elements: an lu interface for providing connection between RNC and CN; an lub interface for providing connection between RNC and NodeB; and an lur interface for providing connection between RNC and RNC. The distributed radio network controller used in the invention adopts standard ATM interfaces as stipulated in 3GPP Release 1999 specification, these interfaces being provided by interface ATM boards. Each interface ATM board may provide one or more optical fibers to connect other corresponding equipments. Each interface ATM board can realize the function of IP/ATM switch, and is connected to a core route switch through a 100 M Ethernet network port to realize data interaction with other functional boards of RNC. The number of interface ATM boards may be arbitrarily increased or decreased according to requirements.

Besides the interface ATM boards, RNC mainly has three classes of functional modules: an Interface management module, a radio signaling management module and a data transmission management module, the functions of which are as follows:

The interface management module is divided into an lu interface management module, an lub interface management module and an lur interface management module. The functions of the lu interface management module comprise: RAB management, lu interface link management, NAS information transmission between UE and CN, etc. The functions of the lub interface management module mainly comprise: cell configuration management, lub interface link management, NodeB operation maintenance, etc. The lur interface management module mainly manages lur interface links to provide communication channels between SRNS and DRNS.

The functions of the radio signaling management module mainly comprise: system message broadcasting management, radio link management between UE and UTRAN, mobility management, radio resources management, outer loop power control, management of signaling/data transmission in the common transmission channel, etc.

The data transmission management module mainly performs data transmission management over the dedicated transmission channel.

In order to ensure non-blocking exchange of data between the respective modules, the radio network controller adopts an IP switching network supporting Qos to achieve communications between the respective modules. The IP switching network comprises a set of concentrator route switches and core route switches all of which support IP DiffServ Qos and can identify and meet, different requirements of quality of service.

The concentrator route switch may serve as an edge router of the switching network, which gathers services from other functional modules of the radio network controller, and classifies, neatens and shapes all the service streams entering into the IP switching network, then deliver classification information of the services (values of DiffServ fields) to the core route switch of the switching network. The concentrator route switch may control or assign DiffServ values of different service streams such as speech, short message, FTP, Email and video. The core route switch provides an 1 G bits Ethernet network port, which generally does not participate in complete service classification, and which reads an IP header and differentiates the services based on additional classification information of the DiffServ fields. The above two route switches can achieve the function of queuing and scheduling.

Each of the functional modules may be realized in one board or realized collectively through a plurality of boards. The number of each type of board may be determined by the process capability of the board, system capacity and the feature of the function to be achieved. Each board is connected to the core route switch through a 100 M Ethernet network port to achieve data interaction between boards.

When a certain functional board of the radio network controller is going to perform data interaction with other functional boards of the radio network controller, the functional board groups the data to be transmitted into IP packets and transmits them to the concentrator route switch which controls or assigns DSCP-DiffServ codepoint in the DifferServ field of the IP packet based on service streams and IP source/destination address, and then forwards the IP packet to the core route switch which in turn forwards the IP packets to the destination board.

It can be seen that, the distributed radio network controller as shown in FIG. 2 comprises the radio signaling management module composed of a plurality of radio signaling management boards, the data transmission management module composed of a plurality of data transmission management boards, a plurality of lub interface ATM boards, an lub interface management board, a plurality of lur interface ATM boards, an lur interface management board, a plurality of lu interface ATM boards and an lu interface management board. When no dedicated connection setup is needed, the functions of signaling continuation, resource allocation and link management are performed by the radio signaling management module and the interface management module cooperatively. When dedicated connection setup is needed, the radio signaling management module specifies a data transmission management board to take charge of processing data transmission and create mapping of routing between respective interface ATM boards and the data transmission management board. Thereafter, the data packets are transferred to the data transmission management board for processing directly through the interface ATM board, and the radio signaling management board and the interface management board are not needed to participate in the processing of the data packets.

When an UE initially accesses to a cell dominated by RNC and transmits data, the radio signaling management board specifies a data transmission management board to take charge of the management of data transmission of UE, and creates the mapping between the interface ATM board and the data transmission management board.

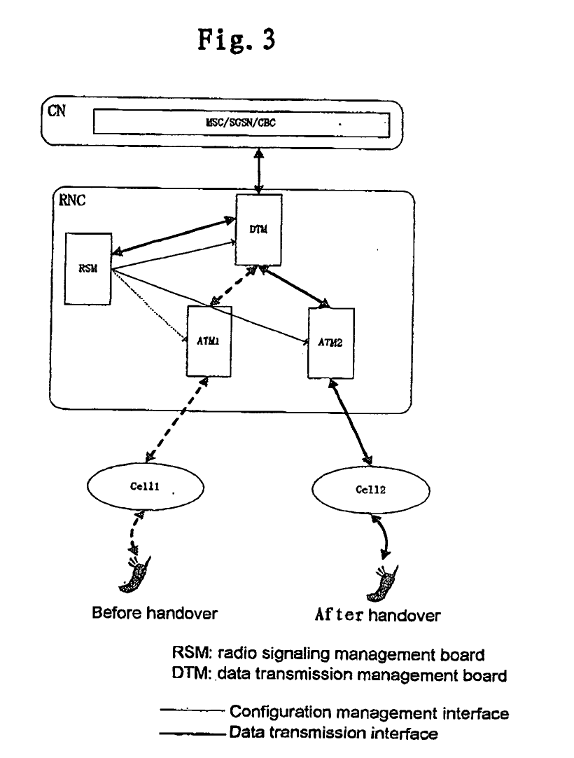

A specific embodiment of the invention will be described below in detail in conjunction with FIG. 3.

When UE initially accesses to cell 1, the radio signaling management board acquires a access request of UE from a first ATM interface board, i.e. the lub interface ATM board 1, and selects for UE a data transmission management board for managing data transmission of UE. Next, the radio signaling management board informs the lub interface ATM board 1 of an index number U-Index of the data transmission management board; the lub interface ATM board 1 acquires the IP address of the data transmission management board from a routing table based on U-Index; the radio signaling management board in turn informs the data transmission management board of an index number A-Index1 of the lub interface ATM board 1; the data transmission management board acquires the IP address of the lub interface ATM board 1 from the routing table based on A-Index1. Thereafter, the radio signaling management board informs UE that the configuration is successful and that data transmission may be started. At this point, downlink data transmission is a transmission of A-Index1 plus data packets from the data transmission management board to the lub interface ATM board 1, and uplink data transmission is a transmission of U-Index plus data packets from the lub interface ATM board 1 to the data transmission management board.

When UE needs to access to a cell 2, UE transmits a handover request from cell 1. The radio signaling management board first acquires the handover request of UE from the interface ATM board 1. After learning that UE will access to cell 2, the radio signaling management board informs a second ATM interface board, i.e. the lub interface ATM board 2, of the index number U-Index of the data transmission management board; the lub interface ATM board 2 acquires the IP address of the data transmission management board from the routing table; the radio signaling management board in turn informs the data transmission management board of an index number A-Index2 of the lub interface ATM board 2; the data transmission management board acquires the IP address of the lub interface ATM board 2 from the routing table and updates the transmission route of data streams of UE. Thereafter, the radio signaling management board informs UE that the configuration is successful and that data transmission may be started. At this point, downlink data transmission is a transmission of A-Index2 plus data packets from the data transmission management board to the lub interface ATM board 2, and uplink data transmission is a transmission of U-Index plus data packets from the lub interface ATM board 2 to the data transmission management board.

As shown in FIG. 3, when UE executes a handover between different cells of the same radio network controller, the route of data transmission only uses different interface ATM boards, and the data transmission management board is still the processing board that was used during the initial call setup. In order to improve the call handling capability of the radio network controller, there may be arranged a plurality of data transmission management boards within a radio network controller. However, for a certain user, when he roams among the cells dominated by the radio network controller, he always uses the same one data transmission management board. In this case, when the user executes handover between the cells of a radio network controller, only the mapping between the data transmission management board and the ATM interface board needs to be reconfigured.

When UE executes handover between the cells, the radio signaling management board first acquires the destination cell to be switched to from the received message of UE. For the radio network controller, there has a fixed mapping between the cells and the ATM interface boards through OAM configuration. The radio signaling management board serves as a control point of the mapping. Therefore, in addition to handling radio signaling, the radio signaling management board needs to store some necessary configuration tables. Preferably, the radio signaling management board needs to store the following mapping table:

Mapping table 1:

| | | | |
|---|---|---|---|
| Cell | Cell scrambling | ATM index | ATM IP |
| identification | code | number | address |

Mapping table 2:

| | |
|---|---|
| data transmission management board | IP address of data transmission |
| identification | management board |

In the call setup, the radio signaling management board specifies for UE a data transmission management board inside the radio network controller according a certain rule, and establishes a route from the interface ATM board to the data transmission management board, then informs the data transmission management board and the interface ATM board of the route information which needs to be stored in the radio signaling management board. The routing information comprises the following items:
UE identification;
cell identification;
ATM index number;
ATM link number (uplink/dowlink); and
data transmission management board identification, etc.

When UE executes handover between different cells, the radio signaling management board search for the mapping between the cells and the interface ATM boards, and reconfigures the mapping between the data transmission management board and the interface ATM board to establish a new data transmission route. Since the same data transmission management board is used before and after the handover, the information data of UE does not need to be shift between different data transmission management boards.

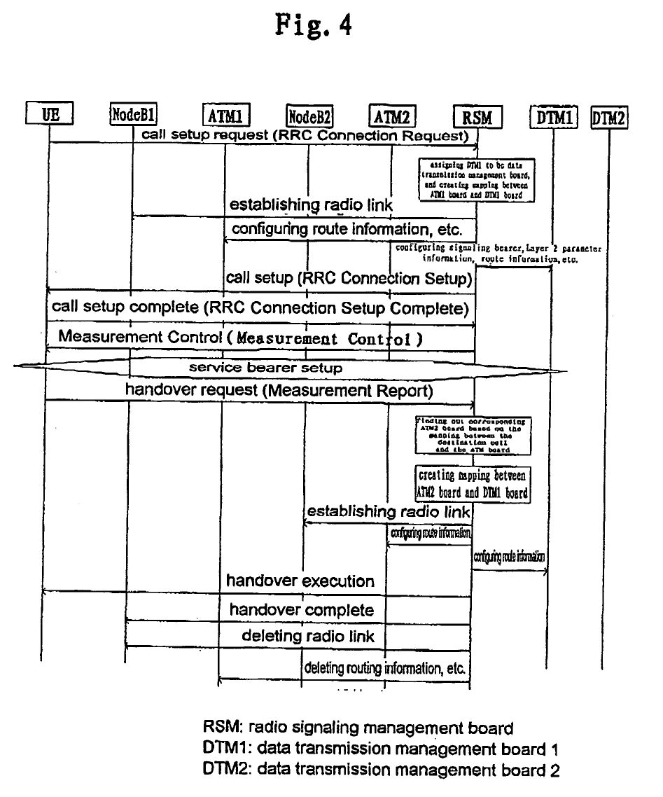

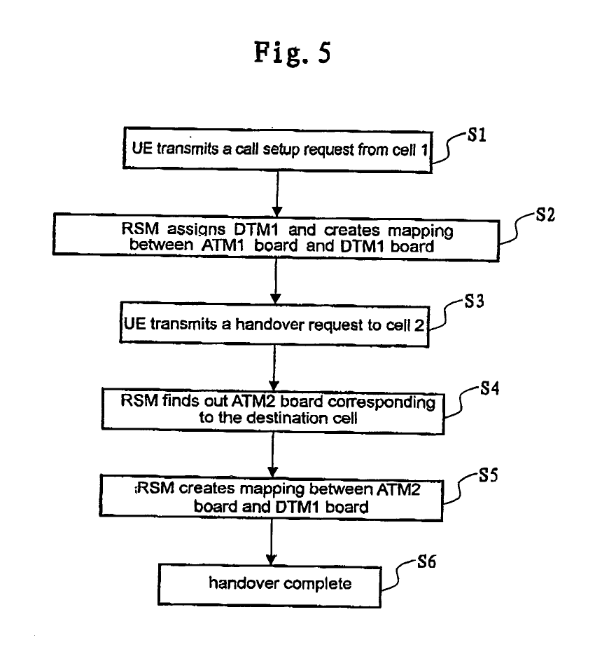

FIG. 4 is a schematic diagram showing a method for managing data transmission during a process from call setup to handover execution. FIG. 5 a flowchart showing a method for managing data transmission during handover of UE within the same one radio network controller.

The combination of FIG. 4 and FIG. 5 clearly shows how to achieve the method for managing data transmission of the invention when UE executes handover between different cells within the same RNC.

As shown in FIG. 4, UE is initially located at NodeB1, and its corresponding interface ATM board is ATM 1. In step S1 of FIG. 5, UE transmits a call setup request from NodeB1. The radio signaling management board RSM assigns for UE a data transmission management board DTM1 within the radio network controller to create the mapping between the ATM1 board and the DTM1 board (step S2 of FIG. 5), and configure signaling bearer, Layer 2 parameter information and route information, etc. for the ATM1 board and the DTM1 board. Thereafter, the radio signaling management board informs UE that the configuration is successful and data transmission may be started. The initial call setup is thus completed.

As the user moves toward NodeB2 and needs to access to NodeB2, UE transmits a handover request from NodeB1 (step S3 of FIG. 5). The radio signaling management board first acquires the handover request of UE from the ATM1 board and learns that UE will access to NodeB2. The mapping table between the cells and the interface ATM boards is stored in the radio signaling management board. The radio signaling management board searches the mapping table to find out the corresponding ATM2 board based on the mapping between the cells and the ATM boards stored therein (step S4 of FIG. 5).

In the case of intra-frequency soft handover, when the user roams from a cell to a neighboring cell, according to 3GPP Release99, the radio network controller deals with the handover based on a received UE measurement report. If the measurement report is triggered by an event 1A, which means that UE requests to establish a radio link in a new cell, the radio network controller perform access control. If the access control is passed, then the link is allowed to add to the active set of UE. The radio network controller allocates corresponding resources, establishes the radio link in the new cell and informs UE of the change of the active set. If the measurement report is triggered by an event 1B, which means that UE requests to interrupt the radio link with a cell having weaker signals, the radio network controller releases corresponding resources, and informs UE of updating of corresponding active set. 3GPP Release99 does not specifically regulate the decision criteria of triggering a hard handover between cells (possibly intra-frequency, inter-frequency or inter-system hard handover). Different system manufacturer will have different strategies. In summary, when the decision criteria of handover is met, the radio network controller will instruct the user to start handover. The radio signaling management board RSM instructs to create the mapping between the ATM 2 board and the DTM1 board (step S5 of FIG. 5), establish a radio link, inform UE of handover complete and deletes the old mapping between ATM1 board and the DTM1 board. The entire handover procedure is thus completed (step S6 of FIG. 5).

FIG. 5 is a flowchart showing the method for managing data transmission during UE handover within the same radio network controller. In step S1, UE transmits a call setup request in cell 1. The interface ATM board 1 associated with cell 1 in which UE is initially located is the ATM1 board. The radio signaling management board RSM assigns for UE the data transmission management board DTM1. In step S2, RSM specifies DTM1 to create the mapping between the ATM1 board and the DTM1 board. The radio signaling management board RSM configures signaling bearer, Layer 2 parameter information and route information, etc. A radio link is established between the radio signaling management board and cell 1, thereby completing the call setup between cell 1 and the radio signaling management board. In step S3, UE transmits a handover request to cell 2. When UE moves toward cell 2 and meets the decision criteria of handover, the radio network controller instructs the user to start handover. The interface ATM board associated with cell 2 is the interface ATM board 2. In step S4, The radio signaling management board RSM finds out the ATM2 board corresponding to the destination cell based on the mapping between the destination cell and the interface ATM board. In step S5, the radio signaling management board RSM creates the mapping between the ATM 2 board and the DTM1 board, configures the route information, establishes a radio link between the radio signaling management board and cell 2, and informs UE of handover complete. In step S6, the radio signaling management board deletes the radio link between cell 1 and the radio signaling management board and the old mapping between the ATM1 board and the DTM1 board. The entire handover procedure is thus completed.

1. A method for managing data transmission during a User equipment (UE) handover procedure used in a Radio Network Controller (RNC) having a distributed architecture, said RNC comprising a plurality of radio signaling management boards, a plurality of data transmission management boards and interface ATM boards, characterized in that the method comprises the following steps:
acquiring a handover request transmitted by UE in cells within the same RNC from a first ATM interface board, by one of the plurality of radio signaling management boards;
creating mapping between one of the plurality of data transmission management boards and a second ATM interface board, by the radio signaling management board, said data transmission management board having mapping to the first ATM interface board before handover; and
informing UE of performing data transmission between the data transmission management board and the second ATM interface board, by the radio signaling management board.

2. A method according to claim 1, characterized in that, the step of creating mapping between one of the plurality of data transmission management boards and a second ATM interface board further comprises the steps of:
causing the second ATM interface board to learn an IP address of the data transmission management board, by the radio signaling management board; and
causing the data transmission management board to learn an IP address of the second ATM interface board, by the radio signaling management board.

3. A method according to claim 2, characterized in that, the interface ATM board obtains its IP address according to an index number of the data transmission management board, and the data transmission management board obtains its IP address according to an index number of the interface ATM board.

4. A method according to claim 1, characterized in that, after handover, the radio signaling management board deletes the mapping between the first ATM interface board and the data transmission management board.
